(19) United States
(12) Patent Application Publication
(10) Pub. No.: US 2023/0273391 A1
(43) Pub. Date: Aug. 31, 2023

(54) OPTO-MECHANICAL MOUNTING FOR OPTICAL COMPONENTS

(71) Applicant: nLIGHT, INC., Camas, WA (US)

(72) Inventors: David Martin Hemenway, Camas, WA (US); Wolfram URBANEK, Camas, WA (US); Kevin Fortier, Camas, WA (US); David C. DAWSON, Camas, WA (US); Eric Martin, Camas, WA (US)

(21) Appl. No.: 18/016,098

(22) PCT Filed: Jul. 12, 2021
(86) PCT No.: PCT/US2021/041330

§ 371 Date: Jan. 13, 2023

Related U.S. Application Data
(60) Provisional application No. 63/051,829, filed on Jul. 14, 2020.

(51) Int. Cl. G02B 7/00

(52) U.S. Cl. CPC G02B 7/00; H01S 3/067

(57) ABSTRACT

An optical component has a bottom part located in an opening defined by a surface, wherein a distance between a sidewall of the bottom part of the optical component and a sidewall of the opening is non-uniform in which a width of a first section of the opening or a first section of the bottom part of the optical component is narrower than a width of a second lower section of the opening or a width of a second lower section of the bottom part of the optical component; and an adhesive is located in the opening between sidewalls.

### PRIORITY

This application claims priority to U.S. Provisional Application No. 63/051,829 filed on Jul. 14, 2020, entitled OPTO-MECHANICAL MOUNTING FOR OPTICS, which is incorporated by reference herein.

### TECHNICAL FIELD

The present disclosure relates to the field of optics, and more particularly to systems including free-space optics modules.

### BACKGROUND

Fiber lasers are widely used in industrial processes (e.g., cutting, welding, cladding, heat treatment, etc.) In some fiber lasers, the optical gain medium includes one or more active optical fibers with cores doped with rare-earth element(s). The rare-earth element(s) may be optically excited (“pumped”) with light from one or more semiconductor laser sources. These semiconductor pump lasers may include multiple semiconductor laser diodes that are optically combined and focused into a single fiber, providing a “pump laser,” that is then in turn often combined with other pump lasers to provide pump light for the fiber laser. These pumps lasers are the primary source of pump energy for a fiber laser. There is great demand for high power and high efficiency diode lasers, the former for power scaling and price reduction (measured in S/Watt) and the latter for reduced energy consumption and extended lifetime. Additionally, fiber coupled pump sources can be used for non-fiber laser applications, including diode pumped solid state lasers or direct diode-light imaging applications.

### BRIEF DRAWINGS DESCRIPTION

The accompanying drawings, wherein like reference numerals represent like elements, are incorporated in and constitute a part of this specification and, together with the description, explain the advantages and principles of the presently disclosed technology.

FIG. 1 illustrates a schematic diagram of an optical component adhered to a surface

FIG. 2A illustrates a cross-sectional view of a schematic diagram of an optic assembly with an opto-mechanical mounting for an optical component, according to various embodiments.

FIG. 2B illustrates an isometric view of the adhesive illustrated in FIG. 2A.

FIG. 3A illustrates a cross-sectional view of a schematic diagram of another optic assembly with an opto-mechanical mounting for an optical component, according to various embodiments.

FIG. 3B illustrates a cross-section of an isometric view of the optic assembly of FIG. 3A.

FIG. 3C illustrates an isometric view of the adhesive illustrated in FIG. 3B.

FIG. 4 illustrates a cross-sectional view of a schematic diagram of another optic assembly with an opto-mechanical mounting for an optical component, according to various embodiments.

FIG. 5 illustrates a cross-sectional view of a schematic diagram of another optic assembly with an opto-mechanical mounting for an optical component, according to various embodiments.

FIG. 6 illustrates a flow chart of a process for mounting an optical component in any optic assembly described herein, according to various embodiments.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

Additionally, the description sometimes uses terms like “produce” and “provide” to describe the disclosed methods. These terms are high- level abstractions of the actual operations that are performed. The actual operations that correspond to these terms will vary depending on the particular implementation and are readily discernible by one of ordinary skill in the art. In some examples, values, procedures, or apparatus’ are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

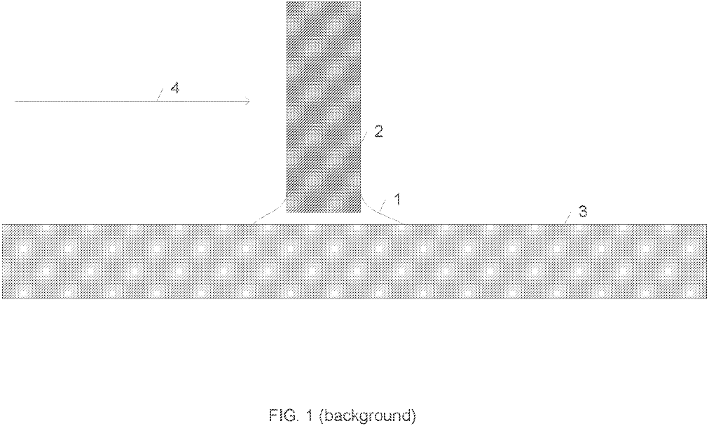

Laser diode modules may employ free-space optic modules that include optical components mounted to a base surface. In some of these free-space optic modules, an adhesive is placed between the bottom of an optical component and the base surface (which may be metal-plated). Specifically, the optical component with adhesive may be placed into contact with a planar surface of the base surface. The adhesive is allowed to cure, which fixes a position of the optical component relative to the base surface provided the adhesive bonds hold. This methodology has the benefit of being inexpensive to manufacture as it is very easy and quick to implement into a production environment. FIG. 1 illustrates such an example, in which an optical component 2 with adhesive 1 is placed on a planar surface of a base 3.

Although the example illustrated in FIG. 1 is low cost and convenient for manufacturing, the optical component 2 can shear off the planar surface of the base 3, or partially break the planar surface, after manufacturing, say, during shipping or in the field. This may be caused by extreme changes in temperature, exposure to impacts (shocks) and vibrations, or combinations thereof. Also, when the planar surface is a smooth metal surface, such as with a metal plated surface, it is more likely the adhesive will break free from the planar surface.

For these reasons, there have been various methods employed to increase the adhesion to the base 3. One approach may be to roughen the planar surface (e.g., bead blasting), which enables a stronger bond between the adhesive 1 and the base 3. Another approach may be to treat the planar surface to change the chemistry (e.g., using “primers” on the planar surface to enable a stronger bond between the adhesive 1 and the base).

While these approaches may improve the strength of the bond, they do not eliminate the possibility of bond failure after manufacture. In the case the bond does fail, the optical component 2 may make movement relative to the base 3. In the case of a diode pump laser, that relative movement may alter a path of the laser beam, which may lead to inoperability of the diode pump laser, poor performance of the diode pump laser, and/or overheating of various components. If integrated into a fiber laser, this may lead to inoperability of the fiber laser, poor performance of the fiber laser, and/or overheating of various components.

For these and other reasons, some systems may employ a mechanical clamp (not shown) to fix a position of the optical component 2 relative to the base 3 independently of the state of the adhesive 1 bond. In these approaches, the mechanical clamp may have a first side fastened to the base 3 (or some other component) and a second side with a clamp holding the optical component 2 in a position fixed relative to the base 3.

Although the mechanical clamp may be suitable for some systems, if the optical component 2 has a small size (e.g., is a micro-optic and/or has dimensions less than ~25.4 mm or 1 inch), the stresses imparted by the mechanical clamp may result in detrimental deformation of the optical component 2. Additionally, the mechanical clamp adds cost to the final product because of the cost to manufacture the mechanical clamp and the cost to assemble the mechanical clamp into the final product. What is needed is a low cost retention mechanism that can fix a position of the optical component 2 relative to the base 3 even in the event of an adhesive bond failure.

Various embodiments of an optic assembly described herein include an optical component and a redundant retention mechanism for fixing a position of the optical component relative to a surface. The redundant retention mechanism fixes a position of the optical component relative to the surface using adhesive bonds, but also prevents movement of the optical component relative to the surface in the event of an adhesive bond failure.

Various embodiments include a recess (e.g., a slot) in the surface. In some embodiments, the base of the slot is wider than the top (opening) of the slot. In some embodiments, the slot may have an isosceles trapezoidal cross-section, which may be referred to as a dovetail groove, in other examples the slot may have any trapezoidal cross-section.

When the dovetail groove is then filled with adhesive, the adhesive and the part of the optical component adhered therein become a dovetail joint that is interlocked with the dovetail groove. The interlocking contains the dovetail joint in six dimensions (e.g., restricted in movement in the X, Y, and Z dimensions and also restricted from Yaw, Pitch, and/or Roll rotation) even if the adhesive bond with the base fails. Accordingly, the dovetail joint not only cannot come free from the slot, but the optical component cannot rotate or move within the slot, either.

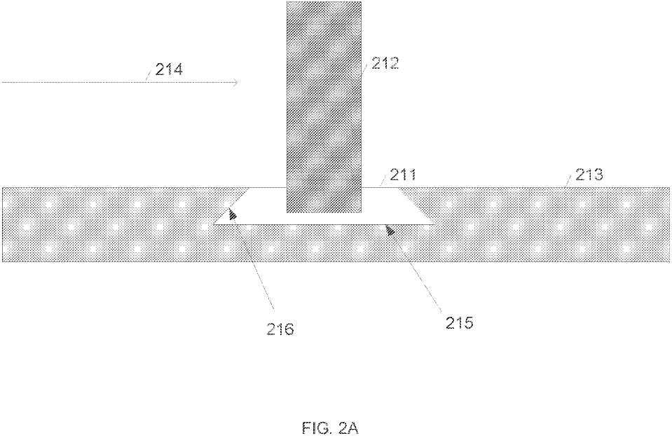

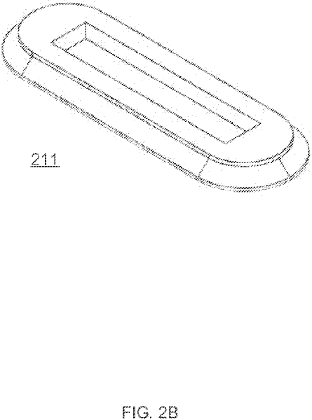

FIG. 2A illustrates a cross-sectional view of a schematic diagram of an optic assembly with an opto-mechanical mounting for an optical component 212, according to various embodiments. The optical component 212 is adhered to the base 213 using an adhesive 211.

The surface of the base 213 defines an opening 215 having an undercut 216. The adhesive 211 may be in a non-solid state (e.g., a liquid or semi-liquid state) when the opening 215 is filled with the adhesive 211. The optical component 212 may be placed in the adhesive 211, and then the adhesive 211 may be allowed to cure (e.g., hardened into a solid form). FIG. 2B illustrates an isometric view of the adhesive 211 illustrated in FIG. 2A.

As explained previously, in the case that the adhesive bond between the adhesive 211 and the base 213 fails (due to, say, poor adhesion to gold-plating or other metal plating on the base 213, or due to contaminants or epoxy cure or chemistry issues), the adhesive 211 (FIG. 2B) in the solid form is still wedged in the opening 215. The adhesive 211 (FIG. 2B) in the solid form may be interlocked in the opening 215, including prevented from rotating in the opening 215. Thus, the optical component 212 adhered to the adhesive 211 is also prevented from rotating relative to the base 213 and/or otherwise moving relative to the base 213 (its movement is restricted in six dimensions, as explained previously).

The optical component 212 may be a lens, a reflector, a partial reflector, or any other optical component to optically process (reflect, refract, etc.) a laser beam 214 or some other light In various embodiments, the optical component 212 may be a polarization multiplexor (PMUX), a main turn mirror (MTM), a meniscus (single component) Fast Axis Telescope (mFAT), or the like. In various embodiments, optical component 212 may be a beam shaping optic, a beam steering optic, or the like, or combinations thereof.

The adhesive 211 may be any material used to bind the optical component 212 to another surface. The adhesive 211 may be an epoxy (consisting of one or more parts), an ultraviolet (UV) cured epoxy, a room temperature vulcanizing (RTV) epoxy, solder, or other joining material transformable from a non-solid state to a solid state in which the material joins the optical component 212 and the base 213 in the solid state.

The optical component 212 and the base 213 may be different materials. In the present embodiment, the adhesive 211 may be optimized to bond with a material of the optical component 212, and a material of the base 213 may be a different material that may not bond as strongly with the adhesive 211. For example, the material of the optical component 212 may be glass and the adhesive 211 may be optimized to bond with glass, but may form a weaker bond with a plated metal of the surface of the base 212 (the base 212 may be metal plated (e.g, gold plated) in some examples). Therefore, the optical component 212 may remain bonded to the adhesive 211 even if a bond between the adhesive 211 and the base 213 fails.

In various embodiments, a material of the optical component 212 may be glass, crystal, plastic, metal, or ceramic. A material of the base 213 may be metal, ceramic, glass, crystal, or any other material used in heat sinks now know or later developed (the base 213 may transfer heat generated by the optical processing of the laser beam 214 by the optical component 212 to a cooling plate or other heat sink thermally coupled to a different part (not shown) of the base 213). In the present example, the base 213 is plated with a material (e.g., gold) that is different than a material of the optical component 212, but other embodiments may be arranged differently in this regard.

The hole 215 may be formed by removing material from a solid block, such as by machining, chemical etching, or laser etching, in various embodiments. In other embodiments, the hole 215 may be formed by additive manufacturing, e.g., the base 213 may be a composite material and formed by 3D printing.

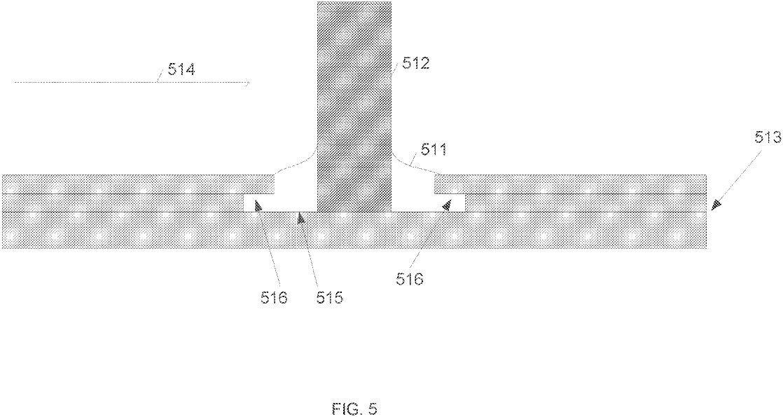

In the illustrated embodiment, the undercut sidewalls are linearly sloped. In other embodiments, these undercut sidewalls may be non-linearly sloped (e.g., curved). Also, while the sidewalls are shown with a uniform slope - this is not required - any slope may be variable with steeper and shallower segments. It may be possible and practical to use any shape for the hole 215 so long as sidewalls of the hole define a non-uniform opening width in which a width of a first section of the hole 215 is narrower than a width of a second lower section of the hole 215 (some embodiments may not have any slope - FIG. 5 illustrates such an embodiment in which the sidewalls have a stair step). It is this aspect that keeps the adhesive 211 wedged in the event of the adhesive bond failure.

Referring again to FIG. 2B, the shape of the adhesive 211 indicates that the undercut may be continuous around the hole 215 (FIG. 2A). However, this is not required. In other examples, the undercut may be non-continuous so that the adhesive 211 has an irregular edge with projections, say, as in a parapet.

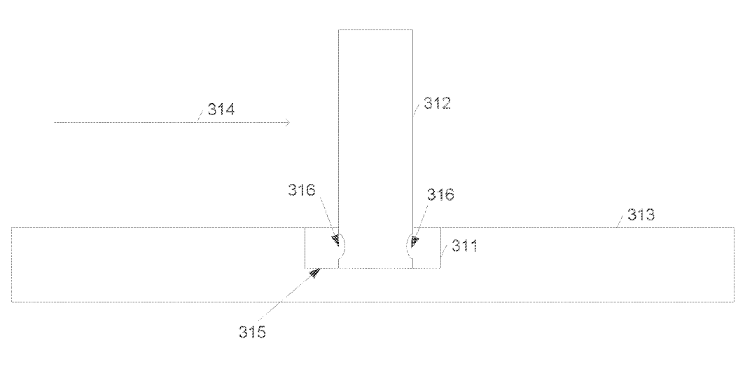

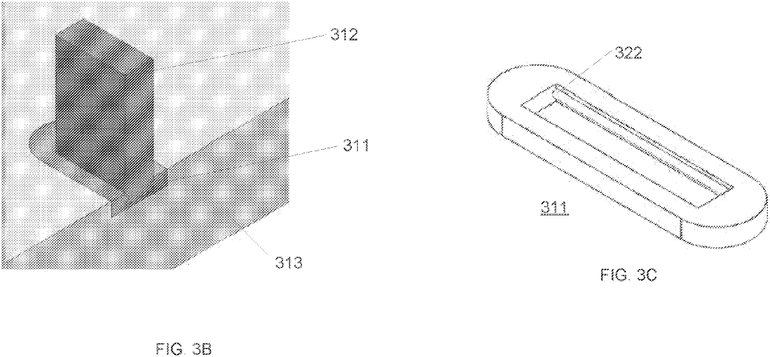

FIG. 3A illustrates a cross-sectional view of a schematic diagram of another optic assembly with an opto-mechanical mounting for an optical component 312, according to various embodiments. The base 313 may be similar to base 213 (FIG. 2A) or any other base described herein in any regard. The optical component 312 may be similar to the optical component 212 (FIG. 2A) or any other optical component described herein in any respect, and the laser beam 314 may be similar to laser beam 214 (FIG. 2A) or any other beam described herein in any respect. The adhesive 311 may be similar to adhesive 211 (FIG. 2A) or any other adhesive described herein in any regard.

A part of the optical component 312 located in the hole 311 may be recessed on both sides to provide recesses 316, as illustrated. In other examples, the recess 316 may be a continuous single recess around the part of the optical component 212 located in the hole 313. Various embodiments may have one or more recesses on one or more sides of the part of the optical component 312 located in the hole 311.

FIG. 3B illustrates a cross-section of an isometric view of the optic assembly of FIG. 3A. The adhesive 311 may be optimized to bond with a material of a surface of the hole 315 (FIG. 3A). In the event of an adhesive bond failure between the adhesive 311 and the optical component 312, the adhesive 311 may prevent the optical component 312 from moving relative to the base 313 in any combination of six dimensions (as previously described). FIG. 3C illustrates an isometric view of the adhesive 311 illustrated in FIG. 3B. The non-vertical sidewall 322 interlocks with a corresponding one of the recesses 316 (FIG. 3A) formed in the sidewall of the part of the optical component 312 located in the hole 315.

Referring again to FIG. 3A, the recesses 316 have a curved continuous bottom. In other examples, instead of the illustrated non-linear slope, linear slopes may be used to form faceted recesses (such as a V-groove or other faceted recess). As explained before, a single continuous recess around the optical component 312 may be used, or plural separate recesses. Referring to FIG. 3C, the non-vertical sidewall could have vertical sections to make an irregular projections, say, as in a parapet.

The optical component 312 may have any shape in which a width of a first section of the bottom part of the optical component 312 is narrower than a width of a second lower section of the bottom part of the optical component 312. In some examples, the bottom part of the optical component 312 may include one or more projections to provide this width (or any other feature that provides one section of the bottom part of the optical component 312 wider than another part of the optical component 312 to anchor the optical component 312 in the hardened adhessive 311). It is this aspect that keeps the adhesive 211 wedged in the event of the adhesive bond failure between the adhesive 211 and the optical component 312.

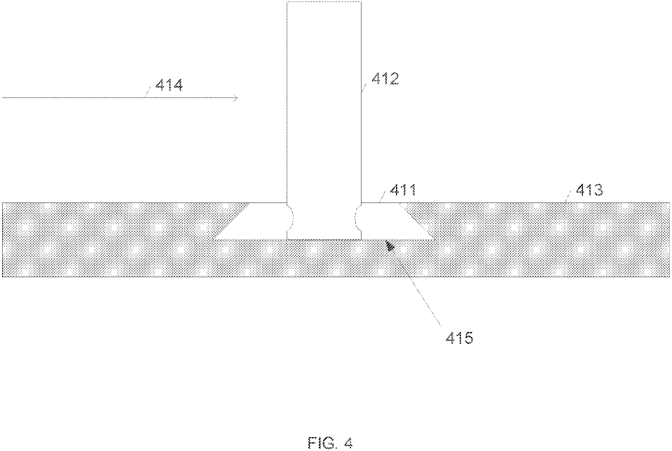

FIG. 4 illustrates a cross-sectional view of a schematic diagram of another optic assembly with an opto-mechanical mounting for an optical component 412, according to various embodiments. The base 413 may be similar to base 213 (FIG. 2A) or any other base described herein in any regard. The optical component 412 may be similar to the optical component 312 (FIG. 3A) or any other optical component described herein in any respect, and the laser beam 414 may be similar to laser beam 214 (FIG. 2A) or any other beam described herein in any respect. The adhesive 411 may be similar to adhesive 211 (FIG. 2A) or any other adhesive described herein in any regard.

In this example, the adhesive 411 may interlock with the hole 415 (due to the illustrated undercutting) and the optical component 412 (due to the illustrated recesses). Therefore, a position of the optical component 412 may be fixed relative to the base 413 in six dimensions in the event of adhesive bond failure between the adhesive 411 and the surface of the base 413 or in the event of adhesive bond failure between the adhesive 411 and the optical component 412.

Although the sidewalls of the opening 415 are undercut in this example, it should be understood that in various embodiment the sidewalls may provide recesses similar to the recesses on the optical component 412. The opening 415 or the bottom part of the optical component 412 in the opening 415 may have any shape in sidewalls of the opening 415 define a non-uniform opening width or the sidewalls of the bottom part of the optical component 412 define a non-uniform optical component width in which a width of a first section of the opening 415 or a first section of the bottom part of the optical component 412 is narrower than a width of a second lower section of the opening 415 or a second lower section of the bottom part of the optical component 412.

FIG. 5 illustrates a cross-sectional view of a schematic diagram of another optic assembly with an opto-mechanical mounting for an optical component 512, according to various embodiments. The optical component 512 may be similar to the optical component 212 (FIG. 2A) or any other optical component described herein in any respect, and the laser beam 514 may be similar to laser beam 214 (FIG. 2A) or any other beam described herein in any respect. The adhesive 511 may be similar to adhesive 211 (FIG. 2A) or any other adhesive described herein in any regard.

The base 513 may be a laminated structure in which different layers are laminated together, as shown, but otherwise may be similar to any base described herein. A top layer of the base 513 may have an opening that is smaller than an opening of the next layer. This may form an opening 515 in which a distance between a sidewall of the bottom part of the optical component 512 and a sidewall of the opening 515 is non-uniform in which a width of a first section of the opening is narrower than a width of a second lower section of the opening 515, similar to the opening 215 (FIG. 2A) in which a similar characteristic is provided using undercuts. The different layers of the base 513 may be the same material or different materials, and may be adhered using any lamination techniques now known or later developed.

The sidewalls of the opening 515 include recesses 516 fillable by the non-solid adhesive 511. In other examples with a base that is not laminated, similar recesses could be formed by removing material from sidewalls or by additive manufacturing. Also, such recesses could have flat surfaces or curved/sloped surfaces.

In the illustrated embodiment, the adhesive 512 is shown as overfilling the hole 515, which provides greater contact surface area with the optical component 512. Overfilling as illustrated may be used in any other embodiment described herein.

In the illustrated embodiment, the optical component 512 is thermally coupled to the base 513 independently of the adhesive 511 (the bottom of the optical component 512 may contact with the thermally conductive material of the base 513). This may be beneficial for removing heat generated by optical processing of the beam 514 by the optical component 512 if the thermal conductivity of the materials of the optical component 512 and the base 513 is greater than a thermal conductivity of the adhesive 511. In embodiments where a rate of thermal dissipation corresponds to a thermal conductivity of the adhesive 511, then the adhesive 511 may be located between an optical component and a base similar to what is shown in FIG. 2A.

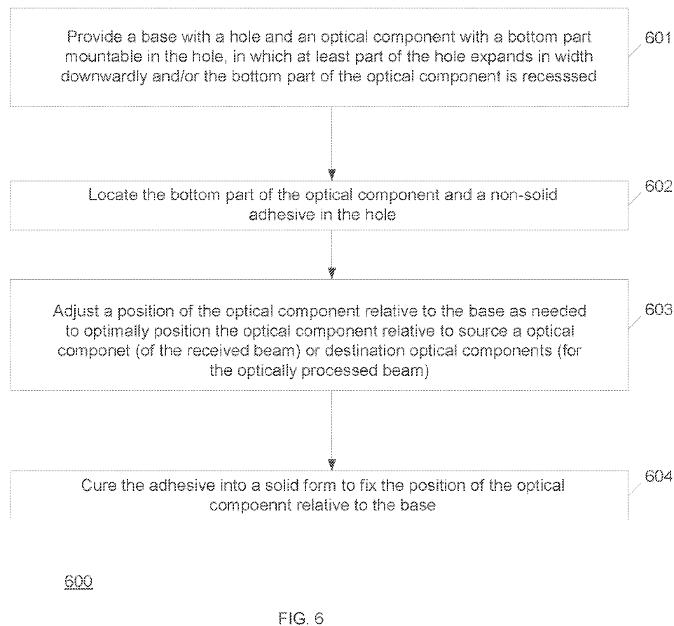

FIG. 6 illustrates a flow chart of a process 600 for mounting an optical component in any optic assembly described herein, according to various embodiments. In block 601, a base with a hole and an optical component with a bottom part mountable in the hole is provided (in which at least part of the hole expands in width downwardly and/or the bottom part of the optical component is recessed or has any other shape in which a section of the bottom part of the optical component has a width that is narrower than a width of a lower section of the bottom part of the optical component).

In block 602, the bottom part of the optical component and a non-solid adhesive may be located in the hole. In block 603, a position of the optical component may be adjusted, if needed, to optimally position the optical component relative to source optical component(s) to provide the beam or destination optical component(s) to receive the optically processed beam from the optical component. Adjustment in block 603 may include an operator actively using a jig to align the optical component with a desired optical path.

After the optical component is in the optimal position, in block 604 the adhesive may be cured into a solid form to fix the position of the optical component relative to the base. In some examples, curing may be using ultraviolet light. The process 600 may be repeated for other optical components mounted to the same base (or located along the optical path and mounted to another base).

Various embodiments described herein may enables more robust assembly of laser diode modules. This assembly may prevent an optical component from breaking free from the surface to which it is attached, reducing the probability of an exception occurring from stray laser light. Any of the principles described herein is not limited to laser diode modules, and may be used in any system in which an optical component to optically processes light is mounted to a base.

### EXAMPLES

Example 1 is a method whereby an optical component is attached to and contained by second surface with adhesive, whereby the second surface contains a slot into which the glass optical component is placed, along with the adhesive. The slot contains internal features that result in the base of the slot being wider than the top of the slot (commonly known as a dovetail cut) and prevents the optical component from separating from the slot due to the hardened (cured) adhesive being contained within the slot in six dimensions. The angle from the top of the slot to the bottom of the slot is approximately 45 degrees.

Example 2 includes the subject matter of example 1 or any other example herein, where the material containing the slot is metal.

Example 3 includes the subject matter of any of examples 1-2 or any other example herein, where the material containing the slot is ceramic.

Example 4 includes the subject matter of any of examples 1-3 or any other example herein, where the material containing the slot is glass or crystal.

Example 5 includes the subject matter of any of examples 1-4 or any other example herein, where the slot has an interior wall angle ranging from 4 degrees (nearly straight walls) to 90 degrees (a rectangular internal feature).

Example 6 includes the subject matter of any of examples 1-5 or any other example herein, where the adhesive used to secure the optical component into the slot is a multi-part epoxy (e.g., hardener and resin), metal solder, RTV epoxy, UV-cured epoxy, thermal cured epoxy, or some combination of these.

Example 7 includes the subject matter of any of examples 1-6 or any other example herein, where the optical component is comprised some other material conducive to the application, such as crystal, plastic, metal or ceramic.

Example 8 is a method where one component, made of a metal, plastic, ceramic or a composite material, is attached to second surface and contained by that second surface with an adhesive, whereby the second surface contains a slot into which the first part is placed, along with the adhesive. The slot contains internal features that result in the base of the slot being wider than the top of the slot and prevents the first part from separating from the slot due to the adhesive being contained within the slot in six dimensions. The angle from the top of the slot to the bottom of the slot is approximately 45 degrees.

Example 9 includes the subject matter of example 8 or any other example herein, where the material containing the slot is metal.

Example 10 includes the subject matter of any of examples 8-9 or any other example herein, where the material containing the slot is ceramic.

Example 11 includes the subject matter of any of examples 8-10 or any other example herein, where the material containing the slot is glass or crystal.

Example 12 includes the subject matter of any of examples 8-11 or any other example herein, where the slot has an interior wall angle ranging from 4 degrees (nearly straight walls) to 90 degrees (a rectangular internal feature).

Example 13 includes the subject matter of example 1 or any other example herein, where the adhesive used to secure the optical component into the slot is a multi-part epoxy (e.g., hardener and resin), metal solder, RTV epoxy, UV-cured epoxy, thermal cured epoxy, or some combination thereof.

Example 14 includes the subject matter of example 8 or any other example herein, where the adhesive used to secure the optical component into the slot is a multi-part epoxy (e.g., hardener and resin), metal solder, RTV epoxy, UV-cured epoxy, thermal cured epoxy, or some combination thereof.

Example 15 includes the subject matter of example 1 or any other example herein, whereby the slot is made my machining the slot into the material with a dovetail cutter.

Example 16 includes the subject matter of example 1 or any other example herein, whereby the slot is made by creating the surface with a 3D printing technology.

Example 17 includes the subject matter of example 1 or any other example herein, whereby the slot is made by laminating two parts together, where one part is solid and a second part has a slot formed into it.

Example 18 includes the subject matter of example 1 or any other example herein, whereby the slot is made my machining the slot into the material with a dovetail cutter.

Example 19 includes the subject matter of example 8 or any other example herein, whereby the slot is made by creating the surface with a 3D printing technology.

Example 20 includes the subject matter of example 1 or any other example herein, whereby the slot is made by laminating two parts together, where one part is solid and a second part has a slot formed into it.

In view of the many possible embodiments to which the principles of the disclosed technology may be applied, it should be recognized that the illustrated embodiments are only preferred examples and should not be taken as limiting the scope of the disclosure. We claim as our invention all that comes within the scope and spirit of the appended claims.

1. An apparatus, comprising:
an optical component; and
a redundant retention mechanism for fixing a position of the optical component relative to a surface, the redundant retention mechanism including:
an opening defined by the surface, wherein a bottom part of the optical component is located in the opening, wherein the sidewalls of the opening define a non-uniform opening width or the sidewalls of the bottom part of the optical component define a non-uniform optical component width in which a width of a first section of the opening or a first section of the bottom part of the optical component is narrower than a width of a second lower section of the opening or a second lower section of the bottom part of the optical component; and
an adhesive located in the opening between sidewalls of the opening and sidewalls of the bottom part of the optical component.

2. The apparatus of claim 1, wherein a cross-section of the opening has a trapezoidal shape, linearly sloped sidewalls, non-linearly sloped sidewalls, or stepped sidewalls.

3. The apparatus of claim 2, wherein the trapezoidal shape comprises an isosceles trapezoidal shape and the opening comprises a dovetail groove.

4. The apparatus of claim 1, wherein the surface comprises a laminated material.

5. The apparatus of claim 1, wherein the surface comprises a composite material.

6. A fiber laser, comprising.
a laser source;
a process head to receive a laser beam derived from laser light of the laser source; and
at least one free-space optics module located on an optical path of the laser beam to optically process the laser beam, the at least one free-space optic module including:\
an optical component; and
a redundant retention mechanism for fixing a position of the optical component relative to a surface, the redundant retention mechanism including:
an opening defined by the surface, wherein a bottom part of the optical component is located in the opening, wherein sidewalls of the opening define a non-uniform opening width or sidewalls of the bottom part of the optical component define a non-uniform optical component width in which a width of a first section of the opening or a first section of the bottom part of the optical component is narrower than a width of a second lower section of the opening or a second lower section of the bottom part of the optical component; and
an adhesive located in the opening between the sidewalls of the opening and the sidewalls of the bottom part of the optical component.

7. The apparatus of claim 6, wherein a cross-section of the opening has a trapezoidal shape, linearly sloped sidewalls, non-linearly sloped sidewalls, or stepped sidewalls.

8. The apparatus of claim 6 wherein the bottom part of the optical component includes a continuous recess around the bottom part of the optical component, the bottom part of the optical component includes two or more recess, or a section that is wider than another section of the bottom part of the optical component, or combinations thereof.

9. The apparatus of claim 6, wherein the surface comprises a laminated material.

10. The apparatus of claim 6, wherein the surface comprises a composite material.

11. An apparatus, comprising:
an optical component having a bottom part located in an opening defined by a surface, wherein a distance between a sidewall of the bottom part of the optical component and a sidewall of the opening is non-uniform in which a width of a first section of the opening or a first section of the bottom part of the optical component is narrower than a width of a second lower section of the opening or a width of a second lower section of the bottom part of the optical component; and
an adhesive located in the opening between sidewalls.

12. The apparatus of claim 11, wherein the opening has a trapezoidal shaped cross-section, linearly sloped sidewalls, non-linearly sloped sidewalls, or stepped sidewalls.

13. The apparatus of claim 12, wherein the opening comprises a dovetail groove.

14. The apparatus of claim 11, wherein the surface is laminated, wherein a hole of a first layer of the laminated surface is above a hole of a second layer of the laminated surface, wherein the hole of the first layer is smaller than the hole of the second layer, wherein the holes form the opening.

15. The apparatus of claim 11, wherein the sidewalls are formed from different materials and one of the materials forms a stronger bond with the adhesive than the other material, wherein the sidewall formed from the other material is undercut or individually defines a recess.

17. The apparatus of claim 11, wherein the adhesive comprises a multi-part epoxy, metal solder, a room temperature vulcanizing (RTV) epoxy, an ultraviolet (UV) cured epoxy, or a thermal cured epoxy.

18. The apparatus of claim 11, wherein the optical component comprises glass, crystal, plastic, metal, or ceramic.

19. The apparatus of claim 18, wherein the optical component comprises a lens or a reflector.

20. The apparatus of claim 11, wherein the surface comprises metal, ceramic, glass, or crystal.
